(19) United States
(12) Patent Application Publication
(10) Pub. No.: US 2017/0188189 A1
(43) Pub. Date: Jun. 29, 2017

(54) A Method, System and Device for Requesting Services At a Mobile Network for One of a Plurality of Mobile User Equipment

(71) Applicant: TELEFONAKTIEBOLAGET LM ERICSSON (PUBL), Stockholm (SE)

(72) Inventors: Peter van Loon, Oosterhout (NL); Hans van Nispen, Breda (NL)

(21) Appl. No.: 15/321,216

(22) PCT Filed: Jul. 11, 2014
(86) PCT No.: PCT/EP2014/064956

§ 371 Date: Dec. 22, 2016

(51) Int. Cl. H04W 4/02; H04W 72/04

(52) U.S. Cl. CPC H04W 4/021; H04W 4/025; H04W 72/0446

(57) ABSTRACT

Method for requesting services at a mobile network for a User Equipment (UE), wherein a geographical home zone for the UE is provided in the mobile network in which location based services are offered to the UE, the method comprising the steps of receiving location information regarding the UE, determining whether the UE is located in or outside the geographical home zone based on the received location information, determining that the UE has entered or left the geographical home zone, transmitting, triggered by the determination that the UE has entered or left the geographical home zone, a spatial trigger message for indicating that the UE has respectively entered or left the geographical home zone, and requesting services for the UE at the mobile network corresponding to whether the UE is located in or outside the geographical home zone.

### TECHNICAL FIELD

The present invention generally relates to a method for requesting services at a mobile network for a User Equipment, (UE) and, more specifically, to method steps performed to determine a Quality of Service relating to the location of the UE.

### BACKGROUND

Location-based services are a particular area within the wider field of wireless access services. A service provider can use knowledge of a terminal's location, for example, to enhance user experience, to create new and potentially valuable revenue streams for the service providers, to provide increased bandwidth settings for the terminals, and to implement particular subscriber tariffs.

A known location-based service such as a Home Zone service provides a mobile customer with both fixed-line and mobile telephone numbers, enabling their contacts to call them at regular fixed-line costs while they are within a certain previously defined area, designated as their Home Zone. As such, the Home Zone service concept comprises that a mobile customer is provided with both a fixed-line number and a mobile number for a single mobile handset.

Traditional voice call based Home Zone services are triggered based on a voice call setup that can be routed to an application running, for example, on an Application Server (AS). On receiving such a voice call setup trigger, the application will do a location check for the mobile User Equipment via the Mobile Location Protocol (MLP), towards a Mobile Positioning System (MPS).

The MLP is a protocol specified by the Open Mobile Alliance (OMA) to provide applications with location information independently of the underlying network technology. It relies upon the delivery of eXtensible Markup Language (XML) documents containing location information from a mobile location centre within the wireless network to a service provider's server, typically using HyperText Markup Language (HTTP) as the transport mechanism.

3rd Generation Partnership Project (3GPP) specifications for wireless network architectures, including e.g. Global System for Mobile Communications (GSM), Universal Mobile Telecommunications System (UMTS) or 3G, and Long Term Evolution (LTE), provide for the determination of location information suitable for use with the MLP. The 3GPP system is referred to here as the Mobile Positioning System, MPS. The MPS is facilitated by a Gateway Mobile Location Centre (GMLC) defined in GSM, UMTS and LTE, or analogously by a Mobile Positioning Centre (MPC) which is defined in the American National Standards Institute (ANSI) standards.

In response to the location check, initialized by the voice call setup trigger, the MPS returns a location area to the location-based application, indicating an area wherein the User Equipment (UE) is located. The indication may be accompanied with a degree of uncertainty, as the location area may be derived from a plurality of different types of events. The Home Zone service may then compare the actual location of the UE with pre-determined location information for that UE, i.e. its Home Zone area, to apply different services like differentiated charging, mobility restriction, etc.

If a Home Zone service is to support data transfer, also known as data burst, next to voice calls, a clear trigger point for the data transfer would have to be available in the telecommunication network. However, such a trigger is difficult to realise as for data transfer it is more complicated to determine when a data transfer is on-going after establishment of a data bearer.

In a telecommunication network, data transfers may have a bursty scattered character with multiple subsequent data transfers, to different locations that often are not detectable from one central point. A setup of a bearer for data transfer is in general a single event whereafter data bursts are transferred. In general the bearer for data transfer may be kept in operation as long as the UE is powered on such that the setup of the bearer does not correspond to the actual transfer of each data burst.

The above mentioned data transfer or burst may be generated by a UE in case of browsing the Internet on the UE, checking and/or sending e-mails, different types of social media activity, automatic application (app) updates, watching video online, etc.

### SUMMARY

It is an object of the present invention to provide for an improved method for requesting Home Zone services at a mobile network for one of a plurality of mobile User Equipment, UE, such that Home Zone services may also be suitable for data transfer.

It is another object to provide for an improved method for indicating a location of one of a plurality of UE in a mobile network, wherein one or more geographical home zones for the UE are provided in the mobile network.

It is a further object to provide for a location server arranged for indicating a location of one of a plurality of mobile User Equipment, UE, in a mobile network, wherein one or more geographical home zones for the UE are provided in the mobile network.

In a first aspect of the invention there is provided a method for requesting services at a mobile network for one of a plurality of mobile User Equipment, UE, wherein one or more geographical home zones for the UE are provided in the mobile network in which one or more home zones, location based, Home Zone, services are offered to the UE, the method comprising the steps of:
receiving, by a location server, location information regarding the UE in the mobile network;
determining, by the location server, whether the UE is located in or outside the one or more geographical home zones based on the received location information;
determining, by the location server, that the UE has entered or left the one or more geographical home zones;
transmitting, by the location server, triggered by the determination that the UE has entered or left the one or more geographical home zones, a spatial trigger message to an application server for indicating that the UE has respectively entered or left the one or more geographical home zones; and
requesting, by the application server, services for the UE at the mobile network corresponding to whether the UE is located in or outside the one or more geographical home zones.

The method is based on the insight that, instead of trying to detect on-going data transfer in the network for a UE, and to use such a detection as a trigger for requesting the location of the UE to determine whether Home Zone services are applicable, the trigger should be originated from the location server itself.

The inventors noted that, generally, a UE only enters or leaves its Home Zone maybe a couple of times a day, while data transfer for the UE is an on-going process, having a plurality of new data transfers during a single day after establishment of one data bearer therefor.

As such, it is more convenient to request services for the UE at the mobile network, being an access network for the UE, corresponding to whether the UE is located in or outside the one or more geographical home zones each time it is observed that the UE enters or leaves the one or more geographical home zones.

A further advantage of the present invention is that the application, running, for example, on the Application Server, is not notified each time a data transfer or session is set up by the UE, resulting in a reduced network overload. This reduction is accomplished as location requests towards the location server, for the location of a UE are not triggered by the set ups of data sessions or transfers, which could occur many times a day.

In the context of the present invention, a service may be directed to any of a bandwidth setting for the UE, tariff setting for the UE, limit setting for the amount of data transfers allowed to be transferred for the UE, security protocols, etc.

According to the present invention, a mobile network is a telecommunications service provider organization that provides wireless voice communication and data transfer for its subscribed mobile users, as well as internet connectivity, at least while the mobile network is connected to the internet, enabling exchanging of data.

One or more geographical Home Zones are mapped to a subscriber and/or a User Equipment. For example, a geographical area covering the actual home of the subscriber may be appointed as a Home Zone for that subscriber, in which that subscriber is entitled to an increased bandwidth setting for its data communication. Further, the subscriber may be coupled to more than one geographical Home Zone, for example its Home address, its Office address, or the like.

In the context of the present invention, location information may be regarded as any type of information from which the geographical location of the UE can be determined or derived. An example is geographical location data coordinates, which are provided to the location server that is arranged to decide whether the location is inside or outside the Home Zone for that UE. In another example, the location server may receive data originating from the UE comprising information regarding which base station the UE is connected to.

In an example, the geographical Home Zone is any of:
at least one cell area covered by a base station of the mobile network;
at least one sector of the cell area covered by the base station;
at least one sub-sector of the sector of the cell area covered by the base station;
a set of Global Positioning System coordinates data.

In another example, the location based, Home Zone, services comprise an increased or decreased data transfer bandwidth setting for the UE.

In yet another example, the step of requesting, by the application server, services at the mobile network corresponding to whether the UE is located in or outside the one or more geographical home zones uses an Internet Protocol, IP, Multimedia Subsystem, IMS, Rx interface.

In a second aspect, there is provided a method for indicating a location of one of a plurality of mobile User Equipment, UE in a mobile network, wherein one or more geographical home zones for the UE are provided in the mobile network in which one or more home zones, location based, Home Zone, services are offered to the UE, the method comprising the steps of:
receiving, by a location server, location information regarding the UE in the mobile network;
determining, by the location server, whether the UE is located in or outside the one or more geographical home zones based on the received location information;
determining, by the location server, that the UE has entered or left the one or more geographical home zones;
transmitting, by the location server, triggered by the determination that the UE has entered or left the one or more geographical Home Zones, a spatial trigger message, for example to an application server, for indicating that the UE has respectively entered or left the one or more geographical home zones.

The inventors noted that, the above stated problem may be solved by adapting a conventional location server such that it is able to perform the method steps according to the present invention. That is, a location server should not await a trigger signal from, for example, an Application Server before it actively checks the location of the UE. The location server is, according to the present invention, arranged to receive location information regarding the UE, and the location server may continuously determine, for example in an active manner, the location of the UE to determine whether the UE has entered or left the one or more Home zones.

Once the location server has determined that the UE has entered or left the one or more geographical Home Zones, it shall transmit a spatial trigger message, for example to an Application Server, for indicating that the UE has respectively entered or left the one or more geographical Home Zones. The Application Server may than request appropriate services, according to the change in location of the UE, in the mobile network.

In order to actively determine the location of the UE, the location server may receive location information from that UE in a continuous manner, or with regular intervals, such that the location server is able to accurately determine the geographical location of the UE. The location information may be comprised in the form of GPS data, or any other type of data from which the geographical location of the UE may be derived.

The spatial trigger message may be in the form of a notifying message comprising information that the UE has entered or left the one or more Home Zone and/or information regarding the actual (geographical) location of the UE and/or information relating to the specific bandwidth setting for the UE. Such a spatial trigger message may at least comprise any type of location information such that an Application Server is able to request services at the mobile network corresponding to whether the UE is in its geographical Home Zone or not.

In an example, the method further comprises the step of:
transmitting, by the location server, a notification message, triggered by the determination that the UE has respectively entered or left the one or more geographical home zones, to the UE for notifying the UE.

The advantage hereof is that the subscriber, i.e. the person responsible for the UE, is notified on the change in location of the UE, i.e. that the UE has entered or left its Home Zone. As such the subscriber may be aware on the services available to the UE, such as increased bandwidth settings in case the UE has entered its Home Zone.

The notification message may comprise information concerning the actual location of the UE, for example in or outside its Home Zone, may comprise information regarding the change of location, for example entered or left its Home Zone, and/or may comprise information regarding the applicable services for the UE for its actual location.

In another example, the method further comprises the step of receiving, by the location server, a subscription message for subscribing a UE to the method.

In order to be able to receive spatial triggers for a specific UE, the Home Zone application, running on the application server should be subscribed to the location server. The subscription message for a UE may comprise an identification of the UE such as a subscription/identification number of the UE, and may comprise the Home Zone area parameters for the UE, such as geographical data defining one or more Home Zones.

In an example, the location server is arranged for maintaining a location database, which location database comprises information whether the UE is located in the one or more home zones, wherein the step of determining that the UE has entered or left the one or more geographical home zones comprises:
comparing, by the location server, the determined location of the UE with the information in the location database.

The location data base may further be arranged to store the Home Zone area parameters for the UE, such that the location database is able to determine whether the determined location of the UE falls within the Home Zone area parameters for the UE.

The above disclosed example is an advantageous, innovative manner to implement the determining step in the location server. By maintaining the location of the UE in a database, and comparing a newly determined location of the UE with the location of the UE stored in the database, the location server may determine whether the UE has left or entered its Home Zone. Next, the stored location of the UE in the database is replaced by the newly determined location of the UE, such that for subsequent compare steps, the location of the UE in the database is up to date.

In a further example, the step of receiving, location information regarding the UE, comprises:
retrieving, by the location server, location information in relation to the UE and received by the location server. Such location information may be comprised in any of different types of event messages triggered by the UE and received by the location server.

The location server may utilize different techniques to determine a location of the UE, i.e. to determine whether the UE is inside or outside its Home Zone. A first technique is related to the determination of geographical coordinates of the UE. The geographical coordinates may be determined utilizing a cellular positioning system using, for example, an uplink time of arrival principle (UL-TOA) or an enhanced observed time difference (E-OTD).

UL-TOA is based on measuring time of arrival of signals from a UE to multiple measurement units, wherein the geographical locations of the measurement units are known. The actual arrival times of a signal at these different measurement units is directly related to the geographical location of the UE in the mobile network. E-OTD is based on the measured OTD between arrivals of bursts of nearby pairs of base transceiver stations. As such, the UE measures the OTD.

Another technique comprises location information retrieval based on base station identification comprised in messages or packets send to and/or from the UE in the mobile network.

In yet another example, the step of receiving, location information regarding the UE, comprises:
receiving, by the location server, location information in relation to the UE.

In a third aspect of the present invention, there is provided a location server arranged for indicating a location of one of a plurality of mobile User Equipment, UE in a mobile network, wherein one or more geographical home zones for the UE are provided in the mobile network in which one or more home zones, location based, Home Zone, services are offered to the UE, the location server comprising:
receiving equipment arranged for receiving location information regarding the UE, in the mobile network;
location equipment arranged for determining whether the UE is located in or outside the one or more geographical home zones based on the received location information;
processing equipment arranged for determining that the UE has entered or left the one or more geographical home zones;
transmitting equipment arranged for transmitting triggered by the determination that the UE has entered or left the one or more geographical home zones, a spatial trigger message to an application server for indicating that the UE has respectively entered or left the one or more geographical home zones.

The location server may comprise a processor and a memory, wherein the memory comprising instructions executable by the processor, whereby the location server is operative to perform any of the methods steps directed to the location server, as disclosed with the examples provided above.

In the context of the present invention, a module, device, equipment, or the like may also be implemented as a computer program running on the processor.

The expressions, i.e. the wording, of the different aspects comprised by the location server according to the present invention should not be taken literally. The wording of the aspects is merely chosen to accurately express the rationale behind the actual function of the aspects.

In accordance with the present invention, different aspects applicable to the above mentioned examples of the method, including the advantages thereof, correspond to the aspects which are application to the location server according to the present invention.

In an example, the location server is arranged for indicating a location of one of a plurality of mobile User Equipment, UE, wherein the transmitting equipment is further arranged for transmitting a notification message, triggered by the determination that the UE has respectively entered or left the one or more geographical home zones, to the UE for notifying the UE.

In a further example, the receiving equipment is arranged for receiving a subscription message for subscribing a UE to the location server.

In another example, the location server is arranged for maintaining a location database, which location database comprises information whether the UE is located in the one or more home zones, wherein the processing equipment is arranged for comparing the determined location of the UE with the information in the location database.

In yet another example, the receiving equipment is arranged for retrieving location information from any of different types of event messages triggered by the UE and received by the location server.

In a fourth aspect of the present invention, there is provided a non-transitory computer-readable storage medium, comprising instructions which, when executed on at least one processor, cause the at least one processor to carry out the method steps according to the examples provided above.

In a fifth aspect of the present invention, there is provided a location server arranged for indicating a location of one of a plurality of mobile User Equipment, UE in a mobile network, wherein one or more geographical home zones for the UE are provided in the mobile network in which one or more home zones, location based, Home Zone, services are offered to the UE, the location server comprising:
receiving module for receiving location information regarding the UE (10), in the mobile network;
location module for determining whether the UE is located in or outside the one or more geographical home zones based on the received location information;
processing module for determining that the UE has entered or left the one or more geographical home zones;
transmitting module for transmitting triggered by the determination that the UE has entered or left the one or more geographical home zones, a spatial trigger message, for example to an application server, for indicating that the UE has respectively entered or left the one or more geographical home zones.

In an example hereof, the transmitting module is further for transmitting a notification message, triggered by the determination that the UE has respectively entered or left the one or more geographical home zones, to the UE for notifying the UE.

In a sixth aspect of the present invention, there is provided a communication system for requesting services at a mobile network for one of a plurality of mobile User Equipment, UE, wherein one or more geographical home zones for the UE are provided in the mobile network in which one or more home zones, location based, Home Zone, services are offered to the UE, the communication system comprising a location server arranged for:
receiving location information regarding the UE in the mobile network;
determining whether the UE is located in or outside the one or more geographical home zones based on the received location information;
determining that the UE has entered or left the one or more geographical home zones;
transmitting, triggered by the determination that the UE has entered or left the one or more geographical home zones, a spatial trigger message to an application server for indicating that the UE has respectively entered or left the one or more geographical home zones;

the communication system further comprising an application server arranged for:
requesting services for the UE at the mobile network corresponding to whether the UE is located in or outside the one or more geographical home zones.

The above-mentioned and other features and advantages of the invention will be best understood from the following description referring to the attached drawings. In the drawings, like reference numerals denote identical parts or parts performing an identical or comparable function or operation.

The invention is not limited to the particular examples disclosed below in connection with a particular type of location server or with a particular type of mobile network.

### BRIEF DESCRIPTION OF THE DRAWINGS

FIG. 1 is a block diagram illustrating an embodiment of a network

FIG. 2 is a flowchart illustrating an embodiment of method steps.

FIG. 3 is a signalling diagram illustrating an exchange of signals in an embodiment of a network.

FIG. 4 is a signalling diagram illustrating an exchange of signals in an embodiment of a network.

FIG. 5 is a block diagram illustrating an embodiment of a location server.

### DETAILED DESCRIPTION

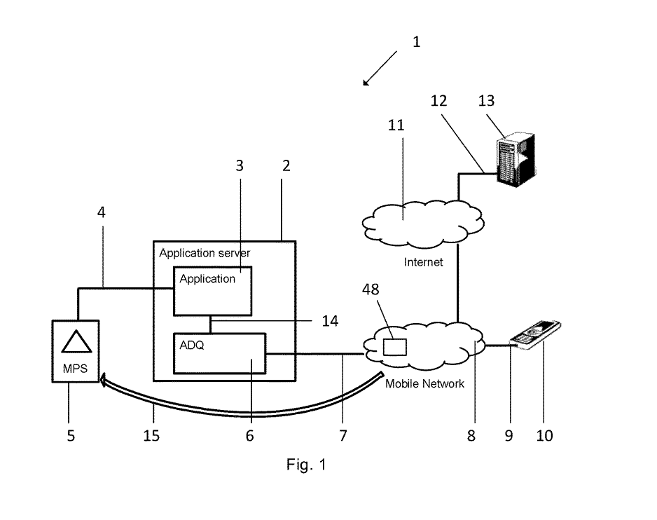

FIG. 1 is a block diagram illustrating a schematic view of a topology 1 according to the present invention, comprising a location server, Mobile Positioning System (MPS) 5, an Application Server 2 and a wireless User Equipment (UE) 10.

The UE 10 is wirelessly connected via link 29 to the mobile network 8, being an access network for the UE 10. The mobile network 8 provides voice services as well as data services to the UE 10, such that the UE 10 is also able, for example, to browse the Internet, check e-mails, perform social media activities, etc., while the mobile network 8 is connected to the Internet 31, enabling exchanging of data.

In the present example, the UE 10 is communicatively connected to a web server 13, hosting a web site, which web server 13 is connected to the Internet 11 via a link 12.

Browsing the Internet 11 is one of the examples in which there is no clear trigger indicating the starting point of data transfer. As such, using conventional methods, such as a voice call setup, the inventors noted that it is not preferable to use a trigger signal originating from the data transfer corresponding to the web browsing activities of the UE 10 for determining the services applicable for the UE 10, as each data transfer would qualify as a trigger, causing in a plurality triggers, resulting a proliferation of network usage.

As such, it is proposed to provide appropriate services in the mobile network 8 for the UE 10 by having the mobile network 8 submit location data signalling, to the location server, MPS 5 which signals the application server 2 whether the UE 10 has either left or entered its Home Zone.

The method presented is based on the insight that the mobile network 8 is enabled to provide actual location data of the UE 10 to the location server, MPS 5. This is visually indicated with reference numeral 15. Additionally, the location server, MPS 5 is arranged to receive the location data and to compile a result whether the actual location of the UE 10 is within or without the boundaries of a previously define Home Zone.

One of the advantages of this method is that the services set in the mobile network 8 for the UE 10 are substantially up to date, such that it is not necessary for the mobile network 8 to request the Application Server (AS) 2 for the location of the UE 10 each time a data transfer of the UE 10 is detected.

The availability of appropriate services for the UE 10 are updated via the location server, MPS 5. These relatively few updates, signalling whether the UE 10 resides in- or outside the Home Zone, amongst other advantages, reduces signalling load in the mobile network 8, and results in less latency for data transfer originating from the UE 10.

Less latency is obtained as the mobile network 8 does not need to request the geographic location of the UE 10 at the location server, MPS 5, via the Application Server (AS) 2, each time a data transfer from the UE 10 is detected.

The location server, MPS 5, is connected via link 4 to an Application Server (AS) 2. This link 24 is used for conveying a spatial trigger message to the Application Server 2 once it is detected that the UE 10 has either entered or left its Home Zone.

An application 3, presented as the Home Zone application, executed on the AS 2 will receive any spatial trigger message sent from the location server, MPS 5. The Home Zone application 3 communicates via link 4 with an Application Driven Quality of Service (ADQ) 6 to set a bandwidth for the UE 10 at the mobile network 8, via link 7.

Having received the current status of the UE 10 with respect to its being inside or outside the Home Zone, the mobile network 8 may be instructed to apply e.g. a specific tariff or apply a specific Quality of Service (QoS).

As an example when the QoS should depend on the location of UE 10, the ADQ 26 functionality requests a Policy and Charging Rules Function (PCRF) 48, comprised by the mobile network 8, for example to adjust the bandwidth to a high Quality of Service (QoS) level for use inside the Home Zone and a reduced QoS level in case the UE is outside the Home Zone.

Alternatively, the ADQ requests a Subscription Policy Repository (SPR) comprised by the mobile network 8, for example to adjust the bandwidth to a high Quality of Server (QoS) lever for use inside the Home Zone and a reduced QoS level in case the UE is outside the Home Zone.

The mobile network 8 handles subsequent data transfer from that UE 10 according to the QoS level set by the ADQ 6. Alternatively the ADQ function is located in a server separate from the AS 2.

The mobile network 8 comprises the PCRF entity 48, arranged for real-time determination of policy rules and making policy decisions for a subscriber's UE 10, such as deploying a certain bandwidth. The PCRF is instructed by the ADQ 6, and may be positioned as a node or function within (as depicted) or external to the mobile network 8.

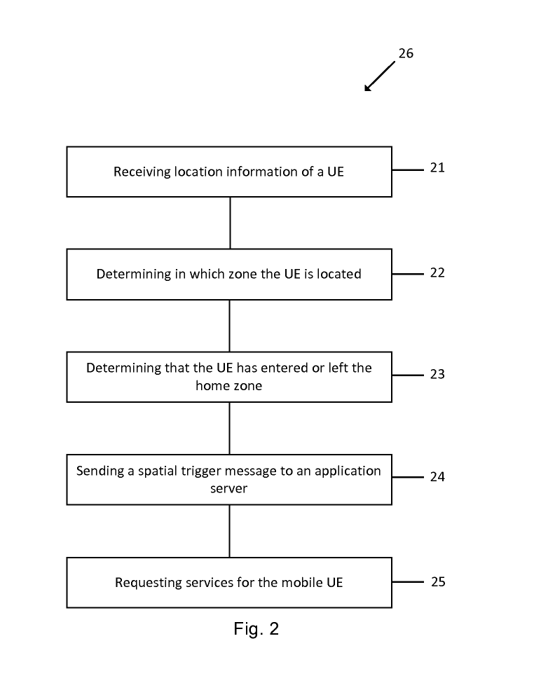

FIG. 2 is a flowchart 26 illustrating a schematic view of a method for requesting services at the mobile network 8 for one of a plurality of the UE 10, wherein one or more geographical Home Zones for the UE 10 are provided in the mobile network 8 in which location based Home Zone services are offered to the UE 10.

It is a preferred that before any step of the method is accomplished, the Home Zone application 23, executed by application server 2 has subscribed to the location server, MPS 5 to receive spatial triggers for (each of the plurality of) the specific UE 10. This subscription process comprises a submission of a subscription message by means of a Mobile Location Protocol (MLP) by application server 2.

The subscription message for each specific UE 10 comprises the subscription/identification number of the UE 10 such as the Mobile Station Integrated Services Digital Network (MSISDN) number, and the Home Zone area parameters, such as geographical data defining the borders of the Home Zone area.

The subscription process is a provisioning process which can provide additional parameters apart from the MSISDN and Home Zone area, such as flags for multiple Home Zones or time/day dependent Home Zones data.

In a first step, the method comprises receiving 21, by the location server, MPS 5, location information regarding the UE 10 from the mobile network 8 as indicated with reference numeral 15. The location information may be a response from the UE 10 to an active location polling request by the location server, MPS 5, or may be any location data information to and/or from the UE which are intercepted by the location server 5, or can be geographical location information based on, for example, power measurements at different base stations for the UE 10. Apart from polling requests, the location data information is in general substantially continuously generated by the mobile network 8. The mobile network 8 is instructed or arranged to submit the location data or location updates of UE's 10 of subscribers to the location server, MPS 5.

Next, it is determined 22, by the location server, MPS 5, whether the UE 10 is located inside or outside the one or more geographical Home Zones based on the received location information. Hereto, the location server, MPS 5 may comprise a set of geographical coordinates resembling the one or more geographical Home Zones for that UE 10. Based on a comparison of the received location information with the set of geographical coordinates, the location server, MPS 5 determines that the UE 10 is actually inside or outside it Home Zone.

Once the actual location with respect to the Home Zone of the UE 10 is determined, i.e. whether the UE 10 is inside or outside its Home Zone, the location server, MPS 5 determines 23 whether the UE 10 has entered or left its Home Zone. To do so, the location server, MPS 5 may compare the actual location data of the UE 10 with a previous value of the location data to determine any geographical change of the UE 10.

Once the location server, MPS 5 has determined that the UE 10 has either left or entered its Home Zone, the location server, MPS 5 transmits 24 a spatial trigger message to the AS 2 for indicating a mutation of the UE's location. As such, the spatial trigger message is sent by the location server, MPS 5 once it is detected that the UE 10 has either entered or left its Home Zone. According to the present invention, transmitting 24 of the spatial trigger message is then considered as triggered by the detection that the UE 10 has entered or left its geographical Home Zone. The spatial trigger message comprises an identifier identifying the UE 10, such as an MSISDN, and a flag indicative for being in- or out-side the Home Zone.

Finally, the AS 2 will request 25 services for the UE at the mobile network 8 corresponding to whether the UE 10 is located inside or outside the one or more geographical Home Zones. The AS 25 may, for example, request a high data transfer bandwidth setting for the UE 10 in case the UE 10 is located in its Home Zone, or may request a zero data transfer bandwidth setting for the UE 10 in case the UE 10 is not located in its Home Zone.

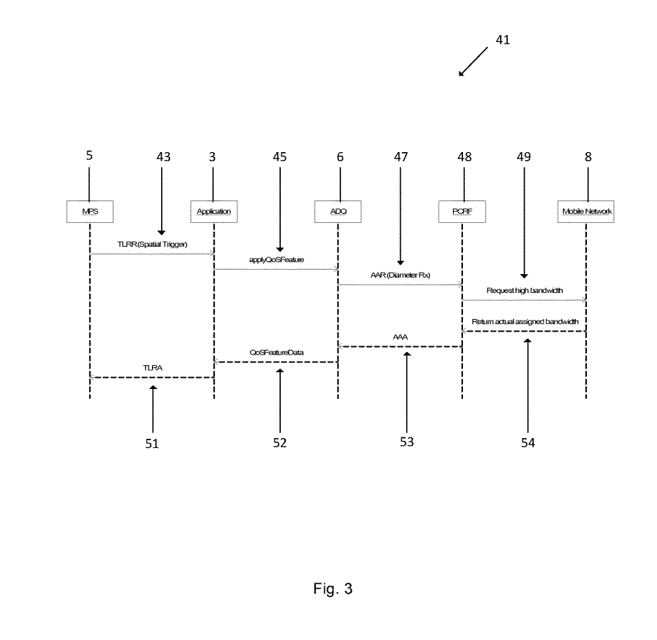

FIG. 3 is a signalling diagram 41 illustrating a schematic view of a method of requesting services at the mobile network 8 for the UE 10, wherein the UE 10 has entered its Home Zone, according to the present invention.

Once the location server, MPS 5, i.e. the Mobile Positioning System, detects that a UE 10 has entered its Home Zone, it will send a spatial trigger message “Triggered Location Reporting Request” (TLRR) 43 towards an application 3 running on, for example, the AS 2.

The Home Zone application 3 will then, subsequently, as an example, indicate a Quality of Service feature message 45 towards the Application Driven QoS, ADQ, 6 running on the AS 2. The ADQ 6 utilizes a diameter message Rx 47 to signal 49 the Policy Control and Charging Rules Function, PCRF, 48 that either the UE 10 has entered its Home Zone or, more concretely, that specific services for the UE 10 should be set.

The PCRF 48 will then, as an example, request a high bandwidth setting 49 at the mobile network 8 for the UE 10. Once the mobile network 8 has set the high bandwidth for the UE 10, the mobile network 8 will acknowledge the actual setting towards the location server, MPS 5 via a return message 54 to the PCRF 48, which will then send an acknowledgement message 53 towards the ADQ 26 running on the AS 2, which will provide the message “QoS_feature_data” 52 to the Home Zone application 3, which will eventually provide the location server, MPS 5 with an acknowledgement message “Triggered Location Reporting Answer” (TLRA) 51.

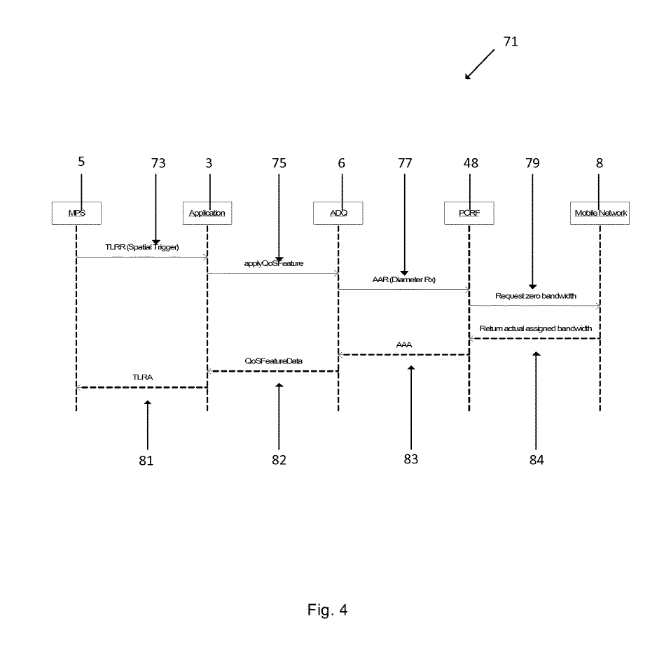

FIG. 4 is a signalling diagram 71 illustrating a schematic view of a method of requesting services at the mobile network 8 for the UE 10, wherein the UE 10 has left its Home Zone, according to the present invention.

The example depicted in FIG. 4 closely resembles the example depicted in FIG. 3, with the difference that UE 10, in the example of FIG. 4, has left its Home Zone instead of that the UE 10 has entered it's Home Zone.

The signalling aspects of FIG. 4, i.e. the spatial trigger message “Triggered Location Reporting Request” (TLRR) 73, the Quality of Service feature message 75, the diameter Rx message 77, the request message 79, as well as the messages indicated with reference numeral 81, 82, 83, 84, have similar functionality compared to the messages indicated with reference numeral 43, 45, 47, 49, 51, 52, 53, 54 in FIG. 3. The difference between these messages is that in FIG. 4 the messages are directed to indicate that the UE has left its Home Zone or to directly request a zero bandwidth for the UE at the mobile network 80, whereas in FIG. 3 these messages are directed to indicate that the UE has entered its Home Zone or to directly request a high bandwidth for the UE.

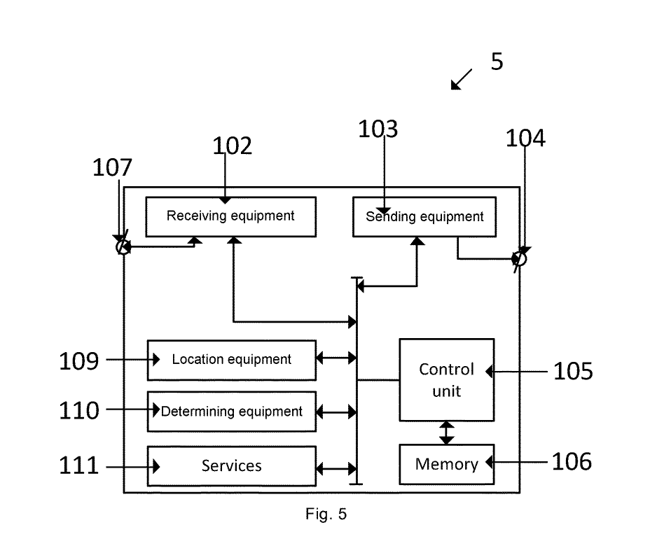

FIG. 5 is a schematic view of the location server, MPS, 5 arranged for indicating a location of one of a plurality of the mobile User Equipment 10 in the mobile network 8, wherein one or more geographical Home Zones for the UE 10 are provided in the mobile network 8 in which location based, Home Zone, services are performed for the UE.

The location server, MPS, 5 comprises a control unit 105 and a memory 106, which control unit 105 is connected to a services module 111, processing equipment 110, location equipment 109, receiving equipment 102 and transmitting equipment 103.

Incoming data packets or messages pass through the input terminal 107 before it reaches the receiving equipment 102, or a receiving module. Outgoing data packets or messages pass or are sent by the transmitting equipment 103, or a transmitting module, via the output terminal 104, for example towards the Application Server 2.

The location equipment 109, or location module, is arranged for determining whether the UE 10 is located inside or outside the one or more geographical home zones based on received location information at the receiving equipment 102. Such location information may, for example, be comprised in the header of incoming data packets at the input terminal 107.

The processing equipment 110, or processing module, is arranged for determining that the UE 10 has entered or left the one or more geographical Home Zones. To do so, the processing equipment 110 may maintain a database comprising the last known location of the UE 10, for example location data relating to whether the UE 10 is inside or outside its Home Zone. Once the processing equipment 110 has newly determined the location of the UE 10, the processing equipment 109 determines whether the new location of the UE is the same or differs from the known location of the UE 10 in the database.

The database may further comprise Home Zone location data for the UE 10, for example geographic coordinates representing areas considered to be the Home Zones for the UE.

The transmitting equipment 103, or transmitting module, is arranged for transmitting, triggered by the determination that the UE 10 has entered or left the one or more geographical Home Zones, a spatial trigger message to the application server for indicating the UE 10 has respectively entered or left the one or more geographical Home Zones.

Optionally, the location server, MPS 5 may comprise a services module 111, which may add information concerning the applicable services for the UE 10 into the spatial trigger message sent to, for example, the Application Server 2. As such, the location server, MPS 5 may control the actual setting of the services, for example a bandwidth setting for the UE 10.

An advantage of the present invention is that less overhead signalling throughout the network is obtained, as the service settings for a particular UE 10 are only updated in case the UE 10 either enters its Home Zone or leaves its Home Zone. Compared to the conventional situation in which each time a data session analogous to a voice call is established, the location server, MPS 5 is actively requested for the location of the UE 10, i.e. whether the UE 10 is inside or outside one of its Home Zones. This advantage is that the number of times the Home Zone is left or entered is in general regarded relatively small, compared to the number of times a burst of data is send or received.

A further advantage of the present invention is that it is no longer needed to construe a method to determine a trigger point of data transfer, as this would be necessary according to conventional Home Zone decision methods for setting appropriate services in the mobile network.

For example, an initial message for establishing a voice call is conventionally used as a trigger for requesting the location server whether the UE 10 is inside or outside its Home Zone. As data sessions are typically an on-going process, deriving a trigger therefrom is difficult. Using the solution according to the present invention, such a trigger for data sessions is no longer needed as the spatial trigger originates indirectly from the UE 10 either entering or leaving its Home Zone, received via the location server, MPS 5, i.e. the trigger is construed by the location server based on data provided by the mobile network 8.

An even further advantage of the present invention is that latency is obviated. In conventional situations, each time a data session when analogously performed as for a voice call is set up by the UE 10, a request for the location of the UE 10 is to be performed to determine which services are applicable for the UE 10, depending on its location with respect to the Home Zone. This leads to an increase in latency, as the results of the request needs to be received before such a communication or appropriate service request can be set up. According to the present invention, the up to date location of the UE 10 is fairly up to date known in the mobile network, i.e. the services applicable for the UE 10 are known in the mobile network, such that no additional latency for a data session to be set up is introduced.

Although the method is presented for data sessions, voice calls may also benefit from this method, by during set up of the voice call check the current status of the Home Zone application 3 indicating the UE's 10 location as either in- or out-side the Home Zone. Thereby bypassing the interrogation of the location server, MPS 5, by the Home Zone application 23.

Another advantage of the present invention is directed to a notification submitted by the Home Zone application 23 and presented on the UE 10, of the UE 10 that it has either entered or left one of its Home Zones.

A signalling to the UE 10 might be performed by e.g. a suitable app or a Short Message Service (SMS). As such, a subscriber, i.e. the owner of the UE 10, is able to determine whether certain services are available to him or not, based on whether the UE 10 is located in its Home Zone or outside its Home Zone.

The present invention is not limited to the embodiments as disclosed above, and can be modified and enhanced by those skilled in the art beyond the scope of the present invention as disclosed in the appended claims without having to apply inventive skills.

1-18. (canceled)

19. A method for requesting services at a mobile network for one of a plurality of mobile User Equipment (UE), wherein one or more geographical home zones for the UE are provided in the mobile network in which one or more location based Home Zone services are offered to the UE, the method comprising:
receiving, by a location server, location information regarding the UE in the mobile network;
determining, by the location server, whether the UE is located in or outside the one or more geographical home zones based on the received location information;
determining, by the location server, that the UE has entered or left the one or more geographical home zones;
transmitting, by the location server and triggered by the determination that the UE has entered or left the one or more geographical home zones, a spatial trigger message to an application server for indicating that the UE has respectively entered or left the one or more geographical home zones; and
requesting, by the application server, services for the UE at the mobile network corresponding to whether the UE is located in or outside the one or more geographical home zones.

20. The method of claim 19, wherein a geographical home zone is any of:
at least one cell area covered by a base station of the mobile network;
at least one sector of the cell area covered by the base station;
at least one sub-sector of the sector of the cell area covered by the base station.

21. The method of claim 19, wherein the location based Home Zone services comprise an increased or decreased data transfer bandwidth setting for the UE.

22. The method of claim 19, wherein the requesting uses an Internet Protocol (IP) Multimedia Subsystem (IMS) Rx interface.

23. A method for indicating a location of one of a plurality of mobile User Equipment (UE) in a mobile network, wherein one or more geographical home zones for the UE are provided in the mobile network in which one or more location based Home Zone services are offered to the UE, the method comprising:
receiving, by a location server, location information regarding the UE in the mobile network;
determining, by the location server, whether the UE is located in or outside the one or more geographical home zones based on the received location information;
determining, by the location server, that the UE has entered or left the one or more geographical home zones;
transmitting, by the location server and in response to determining that the UE has entered or left the one or more geographical home zones, a spatial trigger message for indicating that the UE has respectively entered or left the one or more geographical home zones.

24. The method of claim 23, further comprising receiving, by the location server, a subscription message having Home Zone area parameters for subscribing the UE to the location server.

25. The method of claim 23:
wherein the location server is configured to maintain a location database, the location database comprising information whether the UE is located in the one or more home zones;
wherein the determining that the UE has entered or left the one or more geographical home zones comprises comparing, by the location server, the determined location of the UE with the information in the location database.

26. The method of claim 23, wherein the receiving location information comprises receiving, by the location server, location information in relation to the UE.

27. The method of claim 23, wherein the receiving location information comprises retrieving, by the location server, location information in relation to the UE and received by the location server.

28. A location server configured to indicate a location of one of a plurality of mobile User Equipment (UE) in a mobile network, wherein one or more geographical home zones for the UE are provided in the mobile network in which one or more location based Home Zone services are offered to the UE, the location server comprising:
processing circuitry;
memory containing instructions executable by the processing circuitry whereby the location server is operable to:
receive location information regarding the UE in the mobile network;
determine whether the UE is located in or outside the one or more geographical home zones based on the received location information;
determine that the UE has entered or left the one or more geographical home zones;
transmit, in response to a determination that the UE has entered or left the one or more geographical home zones, a spatial trigger message to an application server for indicating that the UE has respectively entered or left the one or more geographical home zones.

29. The location server of claim 28, wherein the instructions are such that the location server is operable to receive a subscription message having Home Zone area parameters for subscribing the UE to the location server.

30. The location server of claim 28:
wherein the location server is configured to maintain a location database, the location database comprising information whether the UE is located in the one or more home zones;
wherein the instructions are such that the location server is operable to compare the determined location of the UE with the information in the location database.

31. The location server of claim 28, wherein the instructions are such that the location server is operable to retrieve location information in relation to the UE and received by the location server.

32. The location server of claim 28, wherein the location based Home Zone services comprise an increased or decreased data transfer bandwidth setting for the UE.

33. A non-transitory computer readable recording medium storing a computer program product for indicating a location of one of a plurality of mobile User Equipment (UE) in a mobile network, wherein one or more geographical home zones for the UE are provided in the mobile network in which one or more location based Home Zone services are offered to the UE, the computer program product comprising software instructions which, when run on processing circuitry of a location server, causes the location server to:
receive location information regarding the UE in the mobile network;
determine whether the UE is located in or outside the one or more geographical home zones based on the received location information;
determine that the UE has entered or left the one or more geographical home zones;
transmit, in response to determining that the UE has entered or left the one or more geographical home zones, a spatial trigger message for indicating that the UE has respectively entered or left the one or more geographical home zones.

34. A communication system for requesting services at a mobile network for one of a plurality of mobile User Equipment (UE), wherein one or more geographical home zones for a UE are provided in the mobile network in which one or more location based Home Zone services are offered to the UE, the communication system comprising:
a location server; the location server comprising:
processing circuitry;
memory containing instructions executable by the processing circuitry whereby the location server is operable to:
receive location information regarding the UE in the mobile network;
determine whether the UE is located in or outside the one or more geographical home zones based on the received location information;
determine that the UE has entered or left the one or more geographical home zones;
transmit, in response to a determination that the UE has entered or left the one or more geographical home zones, a spatial trigger message to an application server for indicating that the UE has respectively entered or left the one or more geographical home zones;
an application server configured to request services for the UE at the mobile network corresponding to whether the UE is located in or outside the one or more geographical home zones.
